(19) United States
(12) Patent Application Publication
(10) Pub. No.: US 2005/0103589 A1
(43) Pub. Date: May 19, 2005

(54) Backpack with removable handle and wheel assembly

(76) Inventors: Steve Russo, New York, NY (US); Tung Cheng Chi, Kowloon (HK)

Correspondence Address: GOTTLIEB RACKMAN & REISMAN PC, 270 MADISON AVENUE, 8TH FLOOR, NEW YORK, NY, 100160601, US

(21) Appl. No.: 10/827,984

(22) Filed: Apr. 19, 2004

Related U.S. Application Data
(60) Provisional application No. 60/523,780, filed on Nov. 19, 2003.

(51) Int. Cl. B62B 1/00; B62B 7/02

(52) U.S. Cl. 190/18 A; 280/47.18; 280/47.315

(57) ABSTRACT

A bag carrying system having a removable handle and wheel assembly is provided. The system includes a bag having a back portion with a panel overlying the back portion and a handle and wheel assembly comprising a handle portion, a wheel portion and a longitudinally extending supporting element connected therebetween. Significantly, the longitudinally extending supporting unit of the handle and wheel assembly is designed to be placed between the panel and back portion of the bag for releasably attaching the assembly thereto.

### BACKGROUND

This application claims priority benefit of provisional application Ser. No. 60/523,780, filed Nov. 19, 2003.

The present invention relates to luggage and bags, and more particularly to a backpack which may either be worn by using a pair of shoulder straps, carried by means of a handle, or wheeled along a surface by means of a removable handle and wheel assembly.

A recent development in the luggage and bag industry has been the use of wheeled baggage and bags. Luggage and bags of this type typically include a wheel unit and an extendable handle so that the user can pull the luggage or bag unit along a flat surface without having to bear the full weight thereof. Moreover, additional items may be supported along the bag or luggage in order to ease the burden of the use, for example, when moving through airports or along the city and suburban side-walks, or even for high school and college students walking between classes.

The most commonly available luggage or bag item of this type has wheels and an extendable handle permanently attached to the bag item. When the luggage or bag item is not being wheeled, the extendable handle is retracted. The disadvantage of this construction is the difficulty in carrying the luggage or bag since the weight of the wheel and handle assembly is often significant.

Accordingly, it would be desirable to provide a luggage or bag system consisting of a bag and a wheel and handle assembly which may be readily secured to the bag when needed and removed when not needed.

### SUMMARY OF THE INVENTION

Generally speaking, and in accordance with the invention, a bag carrying system having a removable handle and wheel assembly is provided. The system includes a bag having a back portion with a panel overlying the back portion and the handle and wheel assembly comprising a handle portion, a wheel portion and a longitudinally extending supporting element connected therebetween. Significantly, the longitudinally extending supporting unit of the handle and wheel assembly is designed to be placed between the panel and back portion of the bag for releasably attaching the assembly thereto.

In addition, the bag itself includes one or more engaging elements for selective coupling to the longitudinally extending supporting element of the handle and wheel assembly when the supporting element is disposed between the panel and back portion of the bag. The one or more engagement elements comprise one or more locking elements having either a rotating locking mechanism or a spring loaded locking mechanism.

In a preferred form, at least one locking element is located along the top portion of the bag and a second locking element is located along the bottom portion of the bag. These locking elements are designed to selectively couple to transversely extending trays that extend from the longitudinally extending supporting element of the handle and wheel assembly.

In one form, there are two trays extending from the supporting element of the handle and wheel assembly, one of which engages locking members along the top of the bag and a second which engages locking members along the bottom of the bag. These trays are formed with one or more cut-outs that are designed for mating engagement with the locking members.

In its preferred form, the handle and wheel assembly of the invention includes one or more supporting rods that are connected between the handle portions and the wheel portions. The one or more supporting rods are tubular in form in order to telescopically receive corresponding length adjustment rods therewithin.

The inventive design is most applicable to a backpack, which normally includes a pair of shoulder straps each having first and second ends attached to the back portion of the backpack at locations therealong where the panel does not overly the back portion. This is achieved by having the overlying panel disposed between the attached ends of the straps.

In the preferred form, the panel of the backpack or other type of bag comprises a pivotal flat member that is secured along the back portion of the bag. The flap panel is releasably secured to the back portion of the bag by means of a conventional zipper mechanism.

Accordingly, it is an object of the invention to provide an improved bag carrying system.

Another object of the invention is to provide a bag carrying system having a removable handle and wheel assembly.

Yet a further object of the invention is to provide a bag carrying system comprising a backpack or other bag that can be both worn or carried as well as wheeled along a surface.

Still other objects and advantages of the invention will, in part, be obvious and will, in part, be apparent from the following description.

### BRIEF DESCRIPTION OF THE DRAWINGS

For a fuller understanding of the invention, reference is made to the following description, taken in connection with the accompanying drawings in which:

FIG. 1 is an exploded perspective view of the inventive backpack and removable handle and wheel assembly combination;

FIG. 2 is a perspective view of a detailed portion along the top of the backpack, illustrating in one version of a locking unit used to releasably couple the handle and wheel assembly to the backpack;

FIG. 3 is a cross-sectional view taken along line 3-3 of FIG. 2;

FIG. 4 is a top plan view showing the locking unit depicted in FIG. 1 as it engages the upper platform of the inventive removable handle and wheel assembly;

FIG. 5 is a top plan view similar to FIG. 4 and illustrating engagement and locking of the locking unit to the upper platform of the inventive removable handle and wheel assembly;

FIG. 6 is a rear perspective view of the backpack and removable handle and wheel assembly combination of the invention in which the removable handle and wheel assembly is disposed along the rear of the backpack and maintained therealong by a removable flap;

FIG. 7 is a cross-sectional view taken along line 7-7 of FIG. 6 and illustrates the lower platform that extends from the inventive removable handle and wheel assembly engaging to the supporting legs of the backpack;

FIG. 8 is a cross-sectional view similar to FIG. 7 in which the supporting legs (spring-loaded) are pulled downwardly in order to release the lower platform of the removable handle and wheel assembly; and

FIG. 9 is a cross-sectional view taken along line 9-9 of FIG. 8

### DETAILED DESCRIPTION

The inventive system includes a backpack 11 and a removable handle and wheel assembly 31, as best shown in FIGS. 1 and 6. Backpack 11 is made of a fabric-type material and includes a main compartment 13 accessible via a zipper 14 and a supplemental compartment 15 disposed along front panel 25 of compartment 13 and accessible by means of a zipper 16. Backpack 11 also includes a pair of shoulder supporting straps 19 fixed along the rear of the backpack and a reinforced carrying handle 17 fixed along the top of main compartment 13.

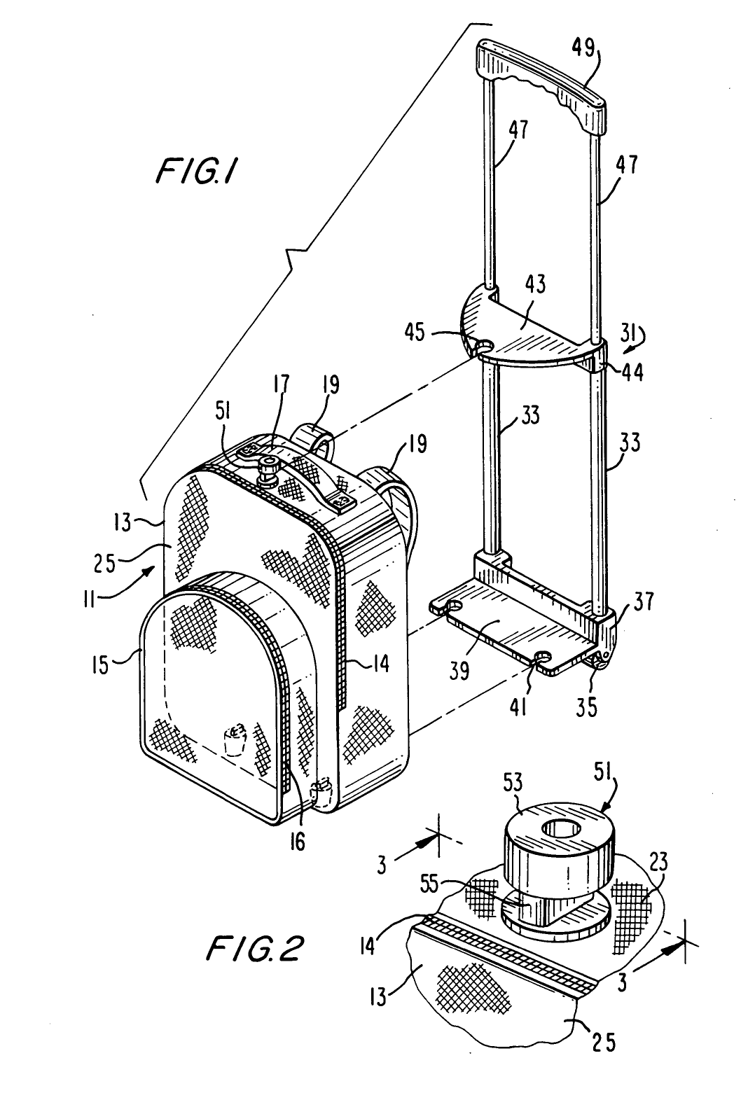

In FIG. 2 and FIG. 3, a locking unit 51 comprising a rotating knob 53, a rectangular lock member 55 rotatable by means of knob 53 and a screw 57 fixed therebetween is shown mounted on top 23 of compartment 13. Locking unit 51 is used to removably attach handle and wheel assembly 31 to backpack 11. One or more locking units of this type may also be formed along bottom 29 of main compartment 13. Alternatively, bottom 29, as shown best in FIGS. 6, 7, and 8, includes a pair of feet 21 affixed thereto by means of a spring loaded pin 61 about which a spring 63 is wrapped. This spring loaded mechanism enables each of feet 21 to be pulled downwardly away from bottom 29 of main compartment 13 so that removable handle and wheel assembly 31 can be selectively coupled to feet 21 as described below. This spring loaded mechanism may be used in place of locking unit 51 along the top of the backpack.

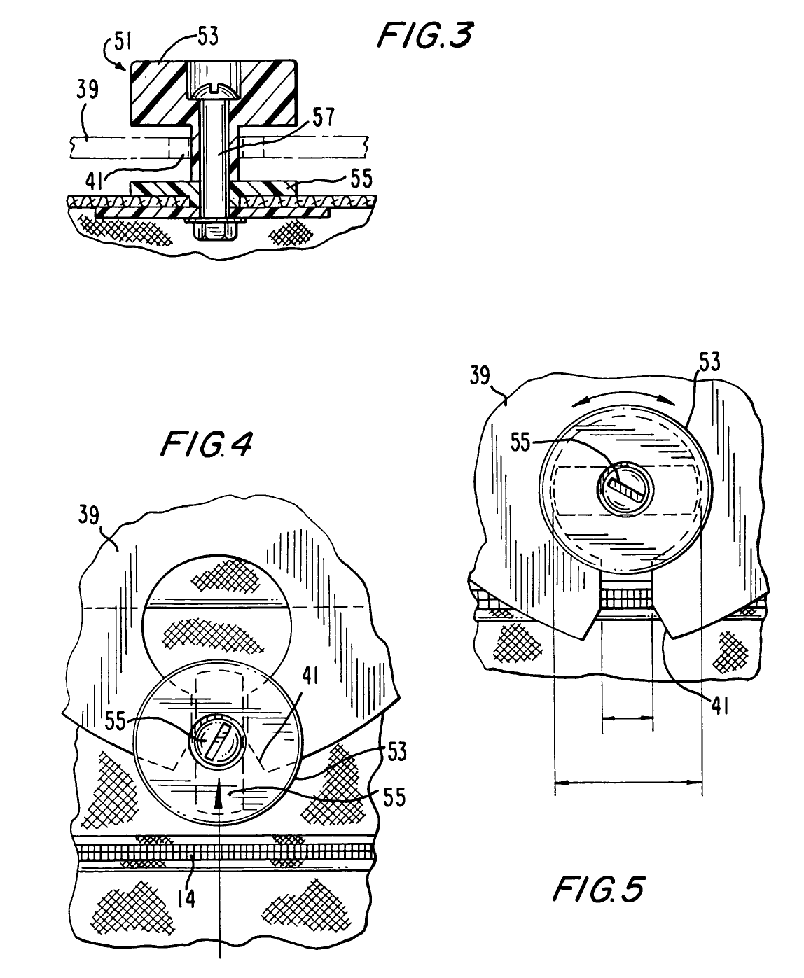

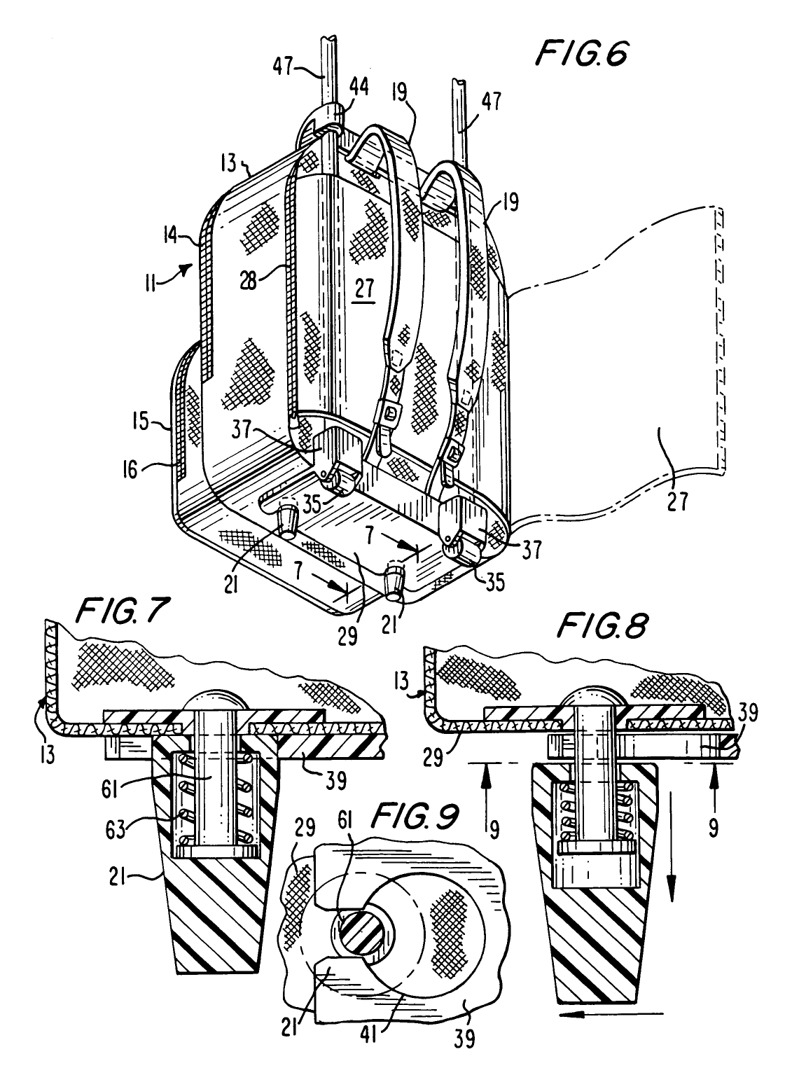

Referring again to FIG. 1, removable handle and wheel assembly 31 comprises metal or plastic support rods 33 extending between an upper platform 43 and a lower platform 39. Support rods 33 at the bottom ends thereof fit into wheel guard supports 37 in which wheels 35 are mounted. Extending from each wheel support 37 is platform 39 formed with a pair of cut-outs 41 used for selectively engaging feet 21 depending from bottom 29 of backpack main compartment 13 (see FIGS. 7-9). At the top of support rods 33 are a pair of platform supports 44 for enabling upper platform 43 to be supported. Platform 43 is formed with a forward notch 45 that is used for selective engagement with locking unit 51 (see FIGS. 3-5). Significantly, support rods 33 are formed with tubular openings therewithin (not shown) such that a pair of upper length or height adjustment rods 47 may be telescopically received therewithin. Rods 47 lead upwardly to a grooved handle 49, which is normally grabbed when wheeling backpack 11. Handle 49 may be disposed in an upper condition during wheeling and a lower condition in which rods 47 are telescopically received within rods 33 such that handle 49 is disposed at the same level as platform 43.

Importantly, the back of backpack 11, as best shown in FIG. 6, is formed with a cushioned panel flap 27 which selectively overlies the back of backpack 11. This enables removable handle and wheel assembly 31 to be disposed between the back of main compartment 13 and flap 27, which is closed by means of zipper 28. In this condition, handle and wheel assembly 31 is usable in conjunction with backpack 11. To remove assembly 31, zipper 28 is unzipped, upper platform 43 is disengaged from locking unit 51 and lower platform 39 is uncoupled from feet 21.

It will thus be seen that the objects set forth above, and those made apparent from the preceding description, are efficiently attained, and since certain changes may be made in the products set forth above without departing from the spirit and scope of the invention, it is intended that all matter contained in the above description and shown in the accompanying drawings shall be interpreted as illustrative and not in a limiting sense.

It is also to be understood that the following claims are intended to cover all the generic and specific features of the invention herein described, and all statements of the scope of the invention, which, as a matter of language, might be said to fall therebetween.

1. A bag carrying system comprising:
a bag having a back portion with a panel overlying said back portion;
a handle and wheel assembly comprising a handle portion and a wheel portion with a longitudinally extending supporting element connected therebetween;
wherein said supporting element of said assembly is selectively disposable between said panel and said back portion of said bag for removably attaching said assembly to said bag.

2. The system of claim 1, wherein said bag further includes at least one engagement element for selectively coupling to said supporting element when said supporting element is disposed between said panel and said back portion of said bag.

3. The system of claim 2, wherein said at least one engagement element comprises at least one locking member for fixed attachment to said supporting element.

4. The system of claim 3, wherein said bag further includes a top portion and a bottom portion, at least one of which having said at least one locking member fixed thereon.

5. The system of claim 4, wherein said supporting element includes at least one substantially transversely extending engagement member for selective coupling with said at least one locking member.

6. The system of claim 5, wherein said at least one engagement member comprises at least one substantially transversely extending tray.

7. The system of claim 6, wherein said at least one tray includes at least one cut-out designed for mating engagement with said at least one locking member.

8. The system of claim 3, wherein said at least one locking member includes a rotatably locking mechanism.

9. The system of claim 3, wherein said at least one locking member includes a spring-loaded locking mechanism.

10. The system of claim 1, wherein said supporting element comprises at least one supporting rod connected between said handle portion and said wheel portion.

11. The system of claim 10, wherein said at least one supporting rod is tubular in form in order to telescopically receive at least one length adjustment rod therewithin.

12. The system of claim 11, wherein said handle portion is fixed to one end of said at least one length adjustment rod.

13. The system of claim 1, wherein said bag comprises a backpack.

14. The system of claim 13, wherein said backpack includes at least one shoulder strap member having first and second ends attached thereto.

15. The system of claim 14, wherein said first and second ends of said at least one strap member are attached to said back psortion of said backpack at locations therealong where said panel does not overly said back portion.

16. The system of claim 15, wherein said overlying panel is disposed between said attached first and second ends of said at least one strap member.

17. The system of claim 1, wherein said panel comprises a panel flap releasably securable along said back portion of said bag.

18. The system of claim 17, wherein said releasable panel flap is selectively secured to said back portion by means of a zipper mechanism.

19. The system of claim 4, wherein said bottom portion of said bag includes said at least one locking member, said at least one bottom portion locking member comprising at least one bag supporting foot.
